(19) United States
(12) Patent Application Publication
(10) Pub. No.: US 2026/0106634 A1
(43) Pub. Date: Apr. 16, 2026

(54) METHOD AND APPARATUS FOR AUTOMATICALLY SWITCHING VEHICLE RADIO FREQUENCY

(71) Applicants: HYUNDAI MOTOR COMPANY, Seoul (KR); KIA CORPORATION, Seoul (KR)

(72) Inventors: Oh Yun Kwon, Hwaseong-si (KR); Jae Kyu Yu, Hwaseong-si (KR)

(73) Assignees: HYUNDAI MOTOR COMPANY, Seoul (KR); KIA CORPORATION, Seoul (KR)

(21) Appl. No.: 19/209,410

(22) Filed: May 15, 2025

(30) Foreign Application Priority Data
Oct. 10, 2024 (KR) 10-2024-0137522

(51) Int. Cl. H04B 1/00

(52) U.S. Cl. CPC H04B 1/0035; H04B 1/0071

(57) ABSTRACT

A method and apparatus automatically switch a vehicle radio frequency. The method includes: receiving, by a first tuner, a first signal at a current frequency at which listening is being performed in a vehicle; determining whether an electric field condition of a second signal received at an alternative frequency meets a first requirement; determining whether a similarity between the first signal and the second signal meets a second requirement in response to a determination that the electric field condition of the second signal meets the first requirement; and automatically switching a reception frequency of the vehicle radio to the alternative frequency in response to a determination that the similarity between the first signal and the second signal meets the second requirement. The first requirement and the second requirement are changed in consideration of noise caused by an electric power steering system of the vehicle.

### CROSS REFERENCE TO RELATED APPLICATION

This application claims priority from Korean Patent Application No. 10-2024-0137522, filed on Oct. 10, 2024, the entire contents of which are hereby incorporated by reference for all purposes.

### TECHNICAL FIELD

The present disclosure relates to a method and apparatus for automatically switching a vehicle radio frequency.

### BACKGROUND

The content described below merely provides background information related to the present disclosure and does not constitute prior art.

Noise generated by an electrical component of a vehicle can affect reception performance of a vehicle radio mounted on the vehicle. In particular, noise generated by an electric power steering (EPS) system may be introduced through an antenna or a body common ground, thereby degrading the reception performance of the vehicle radio.

The conventional method for automatically switching a radio frequency compares a quality of a signal received at an alternative frequency with a quality of the signal received at the frequency at which listening is being performed in a vehicle when an electric field condition of the signal is below a threshold, and when the quality of the signal received at the alternative frequency is good, switches the reception frequency of the radio to the alternative frequency. This conventional method for automatically switching a radio frequency has a problem in that the automatic frequency switching is not performed even when reception performance of a vehicle radio mounted on the vehicle is degraded because it does not take into account noise generated by an electrical component of the vehicle, especially noise introduced by the electric power steering system. For example, when noise is generated by the electric power steering system, such as when the vehicle enters a curved road, the quality of the signal received at the alternative frequency was temporarily lowered, causing a problem in that the automatic frequency switching is not performed.

### SUMMARY

An object of the present disclosure is to provide a method and apparatus for automatically switching a vehicle radio frequency. Specifically, an object of the present disclosure is to provide a method and apparatus for automatically switching a vehicle radio frequency having superior performance compared to the related art by adjusting more than one requirements of automatic frequency switching in consideration of noise caused by an electric power steering system of an vehicle when determining whether the quality of a signal received at an alternative frequency is good and when determining whether a signal received at a frequency at which listening is being performed in the vehicle and the signal received at the alternative frequency are the same broadcast.

The technical objects of the present disclosure are not limited to those described above, and other technical objects not mentioned herein may be understood more clearly by those having ordinary skill in the art from the descriptions given below.

An embodiment of the present disclosure provides a method for automatically switching a vehicle radio frequency. The method includes: receiving, by a first tuner, a signal at a frequency at which listening is being performed in a vehicle (i.e., a first signal); determining whether an electric field condition of a signal received at an alternative frequency (i.e., a second signal) being received by using a second tuner different from the first tuner meets a first requirement; determining whether a similarity between the first signal and the second signal meets a second requirement in response to a determination that the electric field condition of the second signal meets the first requirement; and automatically switching a reception frequency of the vehicle radio to the alternative frequency in response to a determination that the similarity between the first signal and the second signal received meets the second requirement. The first requirement and the second requirement are changed in consideration of noise caused by an electric power steering system of the vehicle.

Another embodiment of the present disclosure provides an apparatus for automatically switching a vehicle radio frequency. The apparatus includes: a memory for storing commands; and at least one processor. The at least one processor is configured to execute the commands to: determine an electric field condition of a first signal received by a first tuner at a frequency at which listening is being performed in a vehicle; determine whether an electric field condition of a second signal received at an alternative frequency being received by using a second tuner different from the first tuner meets a first requirement; determine whether a similarity between the first signal and the second signal meets a second requirement when it is determined that the electric field condition of the second signal meets the first requirement; and automatically switch a reception frequency of the vehicle radio to the alternative frequency when it is determined that the similarity between the first signal and the second signal meets the second requirement. The first requirement and the second requirement are changed in consideration of noise caused by an electric power steering system of the vehicle.

According to one embodiment of the present disclosure, the performance of vehicle radio automatic frequency switching can be improved by adjusting at least one of requirements of automatic frequency switching in consideration of noise caused by the electric power steering system.

The technical effects of the present disclosure are not limited to the technical effects described above, and other technical effects not mentioned herein may be understood to those having ordinary skill in the art to which the present disclosure belongs from the description below.

### BRIEF DESCRIPTION OF THE DRAWINGS

FIG. 1 is a schematic diagram illustrating a vehicle radio system and an electric power steering system of a vehicle according to one embodiment of the present disclosure.

FIG. 2 is a diagram illustrating an operation of a radio signal processing unit according to one embodiment of the present disclosure.

FIG. 3 is a flowchart schematically illustrating a method for automatically switching a vehicle radio frequency according to one embodiment of the present disclosure.

FIG. 4 is a block diagram schematically illustrating a computing device that can be used to implement an apparatus and method for automatically switching a vehicle radio frequency according to one embodiment of the present disclosure.

The drawings described herein are for illustration purposes only and are not intended to limit the scope of the present disclosure in any way.

### DETAILED DESCRIPTION

Hereinafter, some embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

Additionally, various terms such as first, second, A, B, (a), (b), and the like, are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof. When a processor, controller, unit, module, component, device, element, or the like of the present disclosure is described as having a purpose or performing an operation, function, or the like, the processor, controller, unit, module, component, device, element, or the like should be considered herein as being “configured to” meet that purpose or to perform that operation or function. Throughout the present disclosure and claims, where one aspect is said to occur “when” another aspect of the disclosure occurs or has occurred, it can be said that the one aspect occurs “in response to” the other aspect occurring or having occurred. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

The following detailed description, together with the accompanying drawings, is intended to describe embodiments of the present disclosure, and is not intended to represent the only embodiments in which the present disclosure may be practiced.

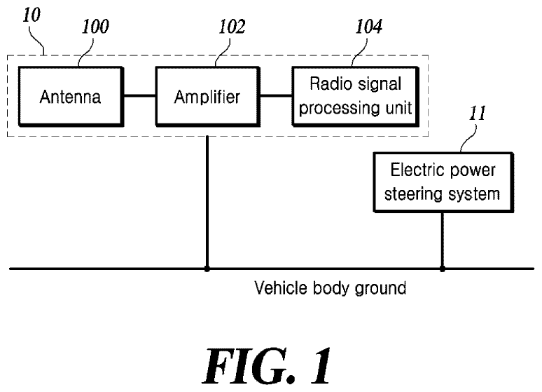

FIG. 1 is a schematic diagram illustrating a vehicle radio system and an electric power steering system of a vehicle according to one embodiment of the present disclosure.

Referring to FIG. 1, a vehicle radio system 10 may include an antenna 100, an amplifier 102, and a radio signal processing unit 104. The vehicle radio system 10 and an electric power steering system 11 may be connected to a vehicle body ground. Noise caused by the electric power steering system 11 may be introduced into the vehicle radio system 10 via the vehicle body ground, thereby affecting the reception performance of the radio.

The antenna 100 may be installed outside or inside the vehicle. The antenna 100 may receive radio signals transmitted in one or more frequency bands. The radio signals may be electromagnetic wave signals. The radio signals may be expressed as amplitude modulation (AM) or frequency modulation (FM) depending on a modulation method.

The amplifier 102 may amplify the radio signal received using the antenna. As a result of the amplification, the signal-to-noise ratio (SNR) of the radio signal may be improved. The amplifier 102 can be a low noise amplifier (LNA).

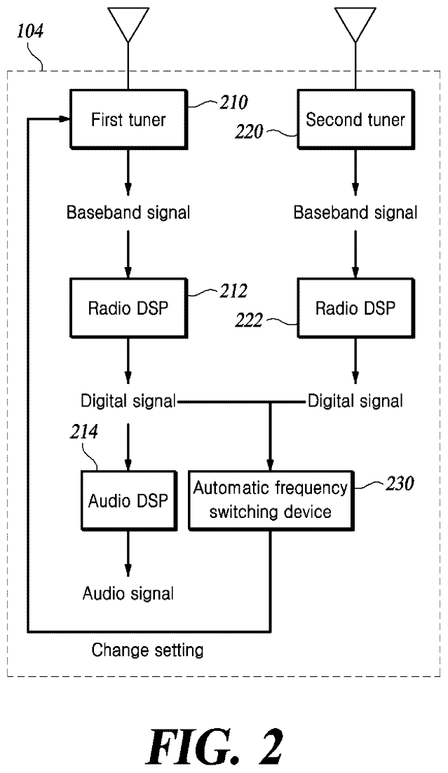

The radio signal processing unit 104 may convert the amplified radio signal into an audio signal that the user can hear. In other words, the radio signal processing unit 104 may convert an electromagnetic wave signal into an audio signal. Additionally, the radio signal processing unit 104 may compare radio signals received from different tuners to determine whether they are the same broadcast, and when they are the same broadcast, perform automatic frequency switching. The radio signal processing unit 104 is described in detail below with reference to FIG. 2.

The electric power steering system 11 is a device that assists an operation of a driver by using an electronic control system. The electric power steering system 11 may generate electrical noise by using an electric motor. The electrical noise may affect an electronic device of the vehicle, such as the vehicle radio system. The noise generated by the electric power steering system 11 may be transmitted to the vehicle radio system through the vehicle body ground.

FIG. 2 is a diagram illustrating the operation of the radio signal processing unit according to one embodiment of the present disclosure.

Referring to FIG. 2, the radio signal processing unit 104 may include tuners 210 and 220, radio digital signal processors (radio DSPs) 212 and 222, an audio digital signal processor (audio DSP) 214, and an automatic frequency switching device 230.

The tuner may be a first tuner 210 or a second tuner 220. The first tuner 210 may be a main tuner, and the second tuner 220 may be a sub tuner. The main tuner may be a tuner that receives a signal at a frequency at which listening is being performed in the vehicle. In other words, the main tuner may receive a signal that matches the frequency of the broadcast at which the listening is being performed in the vehicle. The sub tuner may be a tuner that receives a signal at an alternative frequency. When the vehicle moves, a signal condition may become weak or noise may occur, and in preparation for such a situation, the sub tuner may receive a signal at an alternative frequency other than the frequency at which listening is currently performed. The tuners 210 and 220 may select a frequency of a specific broadcasting station from the frequency band of the broadcasting station. The tuners 210 and 220 may include an amplifier (not illustrated), a filter (not illustrated), a mixer (not illustrated), and an oscillator (not illustrated). The amplifier (not illustrated) included in the tuner may be distinguished from the amplifier 102 of FIG. 1. The amplifier (not illustrated) included in the tuner may be, for example, an intermediate frequency amplifier. The tuners 210 and 220 may demodulate a radio signal and convert the demodulated radio signal into a baseband signal. In other words, the tuners 210 and 220 may demodulate an electromagnetic wave signal and convert the demodulated signal into an analog signal.

The radio DSPs 212 and 222 may convert a baseband signal into a digital signal. In other words, the radio DSPs 212 and 222 may convert a baseband signal demodulated by the tuners 210 and 220 into a digital signal. The radio DSPs 212 and 222 may perform processing such as equalizing, noise reduction, and filtering to improve signal quality.

The audio DSP 214 may convert a digital signal into an audio signal. In other words, the audio DSP 214 may convert a digital signal processed by the radio DSPs 212 and 222 into a final audio signal. The audio signal may be an analog signal. The converted audio signal may be transmitted to a passenger of the vehicle using an output device (not illustrated), for example, a speaker.

The automatic frequency switching device 230 can receive a digital signal converted from a radio signal received using the first tuner 210 and a digital signal converted from a radio signal received using the second tuner 220. The radio signal received using the first tuner 210 may be the signal received at the frequency at which the listening is being performed in the vehicle, and the radio signal received using the second tuner 220 may be the signal received at the alternative frequency. For convenience, hereinafter, the digital signal converted from the radio signal received using the first tuner 210 may be expressed as a signal received at a frequency at which the listening is being performed. Hereinafter, the digital signal converted from the radio signal received using the second tuner 220 may be expressed as a signal received at the alternative frequency.

The automatic frequency switching device 230 may determine whether the electric field condition of the signal received at the frequency at which the listening is being performed to meet the requirement. Specifically, the automatic frequency switching device 230 may determine whether the signal-to-noise ratio calculated based on the signal strength of the signal received at the frequency at which the listening is being performed and the noise strength included in the signal received at the frequency at which the listening is being performed is equal to or greater than a threshold value. When the signal-to-noise ratio is less than the threshold value, it can be determined that the quality of the signal currently being listened to in the vehicle is not good. In other words, when the signal-to-noise ratio is less than the threshold value, the automatic frequency switching device 230 may determine that the electric field condition of the signal received at the frequency at which the listening is being performed does not meet the requirement.

The automatic frequency switching device 230 may determine whether the electric field condition of the signal received at the alternative frequency meets a first requirement. Specifically, the automatic frequency switching device 230 may determine whether the signal-to-noise ratio calculated based on the strength of the signal received at the alternative frequency and the strength of the noise included in the signal received at the alternative frequency is equal to or greater than a threshold value. When the signal-to-noise ratio at the alternative frequency is equal to or greater than the threshold value, the quality of the signal that is not currently being listened in the vehicle, i.e., the signal received at the alternative frequency, may be determined to be good. In other words, when the signal-to-noise ratio at the alternative frequency is equal to or greater than the threshold value, the automatic frequency switching device 230 may determine that the electric field condition of the signal received at the alternative frequency meets the first requirement.

The threshold value for the signal-to-noise ratio may be lowered when the vehicle enters a curved road. When the vehicle enters a curved road, noise generated from the electric power steering system 11 of the vehicle may be introduced into the vehicle radio system 10 and deteriorate the reception performance of the radio. Accordingly, the automatic frequency switching device 230 may relax the criteria for the electric field condition of the signal received at the alternative frequency in consideration of the noise. The criteria for the electric field condition may be the first requirement. For example, the automatic frequency switching device 230 may lower the signal-to-noise ratio threshold (threshold value) by raising the noise strength threshold when the vehicle enters a curved road. In other words, the probability that the quality of the signal received at the alternative frequency is determined to be good may increase. Accordingly, even when the quality of the signal received at the alternative frequency is temporarily lowered due to noise, the automatic frequency switching may be easily performed. In other words, distortion due to noise may be corrected in the radio automatic frequency switching. In this way, the present disclosure can improve the performance of vehicle radio automatic frequency switching by adjusting the requirement of the automatic frequency switching in consideration of noise caused by the electronic component of the vehicle, particularly an electric power steering system.

The automatic frequency switching device 230 may determine whether similarity between the signal received at the frequency at which the listening is being performed and the signal received at the alternative frequency satisfies a second requirement. Specifically, the automatic frequency switching device 230 may calculate a correlation factor between the signal received at the frequency at which the listening is being performed and the signal received at the alternative frequency, and determine whether the correlation factor is equal to or greater than a threshold value based on the calculation result. When the correlation factor is equal to or greater than the threshold value, the signal received at the frequency at which the listening is being performed and the signal received at the alternative frequency may be determined to be the same broadcast. In other words, when the correlation factor is equal to or greater than the threshold value, the automatic frequency switching device 230 may determine that the similarity between the signal received at the frequency at which the listening is being performed and the signal received at the alternative frequency satisfies the second requirement. The correlation factor may have a value between 0 and 1, and the closer the correlation factor is to 1, the higher the probability that the signal received at the frequency at which the listening is being performed and the signal received at the alternative frequency are determined to be the same broadcast. The process of calculating the correlation factor between the signal received from the first tuner 210 and the signal received from the second tuner 220 may be a process of calculating a dual tuner acoustic correlation (DTAC) value.

The threshold value for the correlation factor may be lowered when the vehicle enters a curved road. When the vehicle enters a curved road, noise generated from the electric power steering system 11 of the vehicle may be introduced into the vehicle radio system 10 and deteriorate the reception performance of the radio. Accordingly, the automatic frequency switching device 230 may relax the criteria for the similarity between the signal received at the frequency at which the listening is being performed and the signal received at the alternative frequency in consideration of the noise. The criteria for similarity may be the second requirement. For example, the automatic frequency switching device 230 may lower the correlation factor threshold (threshold value) when the vehicle enters a curved road. In other words, the probability that the two signals are determined to be the same broadcast may increase. Accordingly, even when the similarity between the signal received at the frequency at which the listening is being performed and the signal received at the alternative frequency is temporarily lowered due to noise, the automatic frequency switching can be easily performed. In other words, distortion due to noise can be corrected in automatic radio frequency switching. In this way, in the present disclosure, the performance of vehicle automatic radio frequency switching can be improved by adjusting the requirement of the automatic frequency switching in consideration of noise caused by the electrical component of the vehicle, particularly the electric power steering system.

The automatic frequency switching device 230 can automatically switch the reception frequency of the radio to the alternative frequency when i) it is determined that the electric field condition of the signal received at the alternative frequency satisfies the first requirement and ii) it is determined that the similarity between the signal received at the frequency at which the listening is being performed and the signal received at the alternative frequency satisfies the second requirement. In other words, the automatic frequency switching device 230 can automatically switch the reception frequency of the radio to the alternative frequency when i) it is determined that the quality of the signal received at the alternative frequency is good and ii) it is determined that the signal received at the frequency at which the listening is being performed and the signal received at the alternative frequency are the same broadcast. The process of switching the reception frequency of the radio to the alternative frequency may include a process of changing the setting of the first tuner 210.

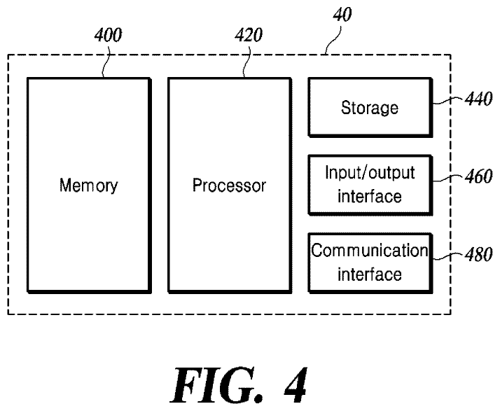

The automatic frequency switching device 230 can be implemented using a computing device 40 (see FIG. 4). One or more of the processes performed by the automatic frequency switching device 230 can be performed by a processor 420 (see FIG. 4) included in the computing device 40. In other words, the processor 420 can determine whether the electric field condition of the signal received at the frequency at which the listening is being performed meets the requirements, determine whether the electric field condition of the signal received at the alternative frequency satisfies the first requirement, and determine whether the similarity between the signal received at a frequency at which the listening is being performed and the signal received at the alternative frequency satisfies the second requirement.

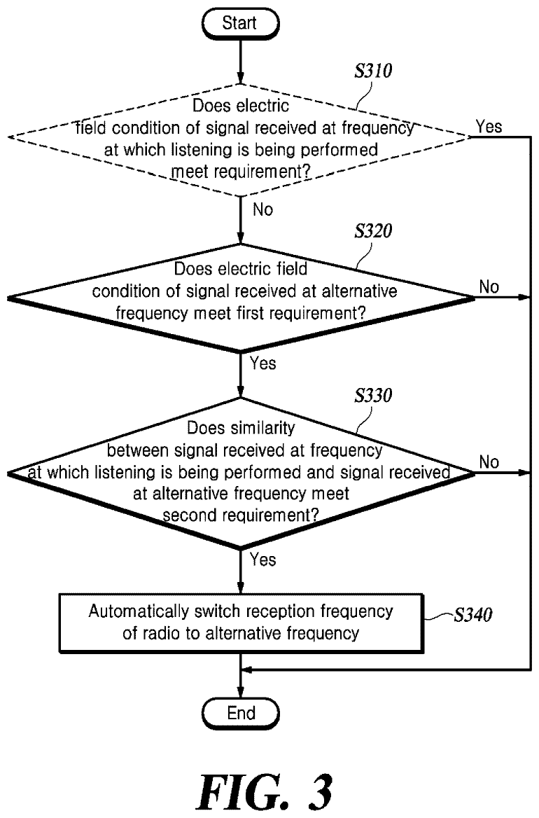

FIG. 3 is a flowchart schematically illustrating a method for automatically switching a vehicle radio frequency according to one embodiment of the present disclosure.

Referring to FIG. 3, optionally, the automatic frequency switching device 230 can determine whether the electric field condition of the signal received at the frequency at which the listening is being performed meet a requirement (an operation S310). Specifically, the automatic frequency switching device 230 may determine whether the signal-to-noise ratio (SNR) of the signal received using the first tuner 210 is equal to or greater than the threshold value. The operation S310 may be a process of determining whether the quality of the signal currently being listened to in the vehicle is good.

The automatic frequency switching device 230 may determine whether the electric field condition of the signal received at the alternative frequency meets the first requirement, when it is determined that the electric field condition of the signal received at the frequency at which the listening is being performed does not meet the requirement (an operation S320). Specifically, the automatic frequency switching device 230 may determine whether the signal-to-noise ratio of the signal received using the second tuner 220 is equal to or greater than the threshold value. The signal received using the second tuner 220, i.e., the signal received at the alternative frequency, may be one or more. In other words, the alternative signal may be one or more. The operation S320 may be a process of determining whether the quality of the alternative signal is good so as to switch the reception frequency of the vehicle from the signal currently being listened to the alternative signal when the quality of the signal currently being listened to in the vehicle is not good.

When it is determined that the electric field condition of the signal received at the alternative frequency meets the first requirement, the automatic frequency switching device 230 may determine whether the similarity between the signal received at the frequency at which the listening is being performed and the signal received at the alternative frequency meets the second requirement (an operation S330). Specifically, the automatic frequency switching device 230 may calculate the correlation factor between the signal received using the first tuner 210 and the signal received using the second tuner 220, and determine whether the correlation factor is equal to or greater than the threshold value. The operation S330 may be a process of determining whether the currently listened signal and the alternative signal are the same broadcast so as to switch the reception frequency of the vehicle from the currently listened signal to the alternative signal when the quality of the alternative signal is good.

The automatic frequency switching device 230 may automatically switch the reception frequency of the radio to the alternative frequency when it is determined that the similarity between the signal received at the frequency at which the listening is being performed and the signal received at the alternative frequency meets the second requirement (an operation S340). S340 may be a process of switching the reception frequency of the vehicle from the signal currently being listened to the alternative signal when it is determined that the signal currently being listened to and the alternative signal are the same broadcast.

In summary, the automatic frequency switching device 230 according to one embodiment of the present disclosure may i) determine whether the quality of the signal currently being listened to in the vehicle is good, ii) if the quality of the signal currently being listened to in the vehicle is not good, then determine whether the quality of the alternative signal is good iii) if the quality of the alternative signal is good, then determine whether the signal currently being listened and the alternative signal are the same broadcast and iv) switch the reception frequency of the vehicle from the signal currently being listened to the alternative signal when the signal currently being listened to and the alternative signal are the same broadcast.

When there is one or more alternative signals, it can be determined whether the alternative signal which is determined to have the best quality is the same broadcast as the signal currently being listened to. In other words, when the electric field condition of the signal received at one or more alternative frequencies meets the first requirement as a result of performing the operation S320 for each of the one or more alternative frequencies, the automatic frequency switching device 230 may first calculate the similarity between the alternative signal having the best signal quality (e.g., the best electric field condition) and the signal currently being listened to. When it is determined as a result of the calculation that the similarity does not meet the second requirement, the automatic frequency switching device 230 may calculate a similarity between the alternative signal having the second-best signal quality and the signal currently being listened to. In this way, when there is one or more alternative signals, the operation S330 may be repeated until there is an alternative signal which meets the requirement. The quality of the alternative signal required for repeating the operation S330 can be measured in S320.

FIG. 4 is a block diagram schematically illustrating a computing device that can be used to implement an apparatus and method according to an embodiment of the present disclosure.

computing device 40 may include all or part of a memory 410, a processor 420, a storage 430, an input/output interface 460, and a communication interface 450. The computing device 40 may be a stationary computing device, such as a desktop computer or a server, or a mobile computing device, such as a laptop computer or a smart phone. The computing device 40 may include a specialized hardware accelerator capable of processing operations of an artificial intelligence model in an efficient manner. For example, the computing device 40 may include a graphic processing unit (GPU), a tensor processing unit (TPU), or a neural processing unit (NPU).

The memory 410 may store a program that enables the processor 420 to perform methods or operations according to various embodiments of the present disclosure. For example, a program may include a plurality of instructions executable by the processor 420, and the methods or operations described above may be performed by executing the plurality of instructions by the processor 420. The memory 400 may consist of a single memory or a plurality of memories. In this case, information required to perform the methods or operation according to various embodiments of the present disclosure may be stored in a single memory or distributed across a plurality of memories. When the memory 400 is composed of a plurality of memories, the plurality of memories may be physically separated. The memory 400 may include at least one of volatile memory and non-volatile memory. Volatile memory includes Static Random Access Memory (SRAM) or Dynamic Random Access Memory (DRAM), while non-volatile memory includes flash memory.

The processor 420 may include at least one core capable of executing at least one instruction. The processor 420 may execute instructions stored in the memory 400. The processor 420 may consist of a single processor or a plurality of processors.

The storage 440 maintains stored data even if power supplied to the computing device 40 is cut off. For example, the storage 440 may include non-volatile memory or may include a storage medium such as a magnetic tape, an optical disk, or a magnetic disk. A program stored in the storage 440 may be loaded into the memory 400 before being executed by the processor 420. The storage 440 may store files written in a program language, and a program created from the files by a compiler may be loaded into the memory 400. The storage 440 may store data to be processed by the processor 420 and/or data processed by the processor 420.

The input/output interface 460 may provide an interface with an input device such as a keyboard or a mouse and/or an output device such as a display device or a printer. The user may trigger execution of a program by the processor 420 through the input device and/or check the processing results of the processor 420 through the output device 460.

The communication interface 480 may provide access to an external network. The computing device 40 may communicate with other devices through the communication interface 480.

Each element of the apparatus or method in accordance with an embodiment of the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an example description of the technical idea of one embodiment of the present disclosure. In other words, those having ordinary skill in the art to which one embodiment of the present disclosure belongs may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed disclosure. Therefore, embodiments of the present disclosure have been described for the sake of brevity and clarity. The scope of the technical idea of the present disclosure is not limited by the illustrations. Accordingly, one of ordinary skill would understand that the scope of the claimed disclosure is not to be limited by the above explicitly described embodiments but by the claims and equivalents thereof.

What is claimed is:

1. A method for automatically switching a vehicle radio frequency, the method comprising:
receiving, by a first tuner, a first signal at a frequency at which listening is being performed in a vehicle;
determining whether an electric field condition of a second signal received at an alternative frequency being received by using a second tuner different from the first tuner meets a first requirement;
determining whether a similarity between the first signal and the second signal meets a second requirement in response to a determination that the electric field condition of the second signal meets the first requirement; and
automatically switching a reception frequency of a vehicle radio to the alternative frequency in response to a determination that the similarity between the first signal and the second signal meets the second requirement,
wherein the first requirement and the second requirement are changed in consideration of noise caused by an electric power steering system of the vehicle.

2. The method of claim 1, wherein determining whether the electric field condition of the second signal meets the first requirement includes determining whether a signal-to-noise ratio (SNR) calculated based on signal strength of the second signal and noise strength included in the second signal is greater than or equal to a threshold value.

3. The method of claim 2, wherein the threshold value is lowered in response to the vehicle entering a curved road, considering the noise caused by the electric power steering system of the vehicle.

4. The method of claim 1, wherein determining whether the similarity between the first signal and the second signal meets the second requirement includes determining whether a correlation factor between the first signal and the second signal is greater than or equal to a threshold value.

5. The method of claim 4, wherein the threshold value is lowered in response to the vehicle enters a curved road, considering the noise caused by an electric power steering system of the vehicle.

6. An apparatus for automatically switching a vehicle radio frequency, the apparatus comprising:
a memory for storing commands; and
at least one processor,
wherein the at least one processor is configured to execute the commands to
determine an electric field condition of a first signal received by a first tuner at a frequency at which listening is being performed in a vehicle,
determine whether an electric field condition of a second signal received at an alternative frequency being received by using a second tuner different from the first tuner meets a first requirement,
determine whether a similarity between the first signal and the second signal meets a second requirement when it is determined that the electric field condition of the second signal meets the first requirement, and
automatically switch a reception frequency of a vehicle radio to the alternative frequency when it is determined that the similarity between the first signal and the second signal meets the second requirement, and
wherein the first requirement and the second requirement are changed in consideration of noise caused by an electric power steering system of the vehicle.

7. The apparatus of claim 6, wherein the processor is further configured to execute the commands to determine whether the electric field condition of the second signal meets the first requirement by determining whether a signal-to-noise ratio (SNR) calculated based on signal strength of the second signal and noise strength included in the second signal is greater than or equal to a threshold value.

8. The apparatus of claim 7, wherein the threshold value is lowered when the vehicle enters a curved road, considering the noise caused by the electric power steering system of the vehicle.

9. The apparatus of claim 6, wherein the processor is further configured to execute the commands to determine whether the similarity between the first signal and the second signal received at the alternative frequency meets the second requirement by determining whether a correlation factor between the first signal and the second signal is greater than or equal to a threshold value.

10. The apparatus of claim 9, wherein the threshold value is lowered when the vehicle enters a curved road, considering the noise caused by the electric power steering system of the vehicle.
